(19) United States
(12) Patent Application Publication
(10) Pub. No.: US 2012/0163940 A1
(43) Pub. Date: Jun. 28, 2012

(54) TRANSPORT SYSTEM

(76) Inventor: Ludger Westrick, Velen-Ramsdorf (DE)

(21) Appl. No.: 13/378,205

(22) PCT Filed: Dec. 23, 2010
(86) PCT No.: PCT/EP10/58473

§ 371 Date: Mar. 7, 2012

(30) Foreign Application Priority Data
Jun. 16, 2009 (GB) 20 2009 008 416.7
Jan. 19, 2010 (DE) 20 2010 001 181.7
Jun. 1, 2010 (DE) 20 2010 007 467.3

(51) Int. Cl. B60P 1/64; B60P 7/06

(52) U.S. Cl. 410/52

(57) ABSTRACT

A transport system having a loading frame disposed in or placeable in a cargo area of a transport vehicle and at least one loading floor that is insertable in the loading frame and removable from the loading frame. The loading frame includes posts and floor supports mounted thereon for receiving the loading floor. The transport system includes a locking system having interacting locking elements for securely and releaseably locking the loading floor for transport in the loading frame on the floor supports and/or posts and on each or the loading floor. The loading floor includes a fastening arrangement for at least one cargo securing apparatus for securing cargo to be transported on the loading floor. The cargo can be placed on the loading floor outside of the cargo area and can be fixed by the cargo securing apparatus for transport before the loading floor is placed in the loading frame.

### BACKGROUND OF THE INVENTION

The invention relates to a transport system having a loading frame disposed in or that can be brought into a cargo area of a transport vehicle and at least one loading floor that can be inserted in the loading frame and removed from the loading frame, wherein the loading frame comprises posts and floor supports mounted thereon for receiving the at least one loading floor.

A transport system of the aforementioned type is generally known as multi-level loading system in the transport of goods with transport vehicles. According to the known prior art, a plurality of loading floors are, therein, arranged one on top of the other in rack-like loading frames inside the cargo area body, in order to reach a volume utilization for general cargo transport that is as full as possible. However, the type and size of the general cargo to be transported may vary considerably, above all in line operation. To compensate for this, the known multi-level loading systems provide the possibility of installing the loading floors at different heights inside the cargo area. However, this is relatively troublesome because this modification must be made inside the cargo area body which has possibly already been loaded in part because stations were approached before. In addition, the driver is responsible for securing the goods for transport and must, therefore, secure the goods for transport on the multi-level loading floors by himself. To achieve this, he needs ample access to the individual pieces of the cargo, with the result that a close arrangement of levels to allow optimal space utilization is impossible. If close loading is aimed at, there is, therefore, the risk that the cargo is secured only inadequately in careless manner due to poor accessibility.

In practical terms, document GB 841 535 A shows cargo securing means for transport vehicles and containers, more particularly for railway cars. Vertical locking rails are securely arranged in the cargo area of the transport vehicle, wherein horizontal beams extending in longitudinal and transverse directions can be connected to said vertical locking rails in a detachable manner. These beams are provided either for securing the cargo in the cargo area or for receiving horizontal intermediate floors or vertical intermediate walls. The drawbacks described in the above paragraph are also found here.

Document DE 30 36 480 A1 shows a take-apart shelf pallet which consists of a three-dimensional frame into which loading floors can be inserted. This shelf pallet is intended for storage purposes and intra-company transport. Since there are not enough possibilities to secure the inserted pallets or loading floors, however, this shelf pallet is not suitable as a transport system for a transport vehicle.

Document DE 195 33 784 A1 describes a truck with loading beams that are arranged one on top of the other. Vertical locking rails are securely arranged in the cargo area of the vehicle, wherein the horizontal loading beams that are extending in longitudinal and transverse directions can be connected to said vertical locking rails in a detachable manner. These beams serve to receive horizontal intermediate floors such as, in particular, standard pallets, such as europallets, on which cargo can be placed. In contrast to the document first mentioned with regard to the prior art, the vehicle here does not have any secure lateral walls but rather stakes to which the horizontal loading beams that are extending in longitudinal and/or transverse directions are to be mounted in a detachable manner. However, the aforementioned drawbacks are also found here because the cargo must be secured in the vehicle, for example, by fixing pallets with cargo securing beams that are extending in transverse and longitudinal directions and must be mounted manually. According to experience, this is connected with a high risk of errors which is proved in practice by the often negative results of goods traffic controls.

### SUMMARY OF THE INVENTION

The present invention, therefore, aims at creating a transport system of the aforementioned type, which obviates the drawbacks disclosed above and in which the cargo can be safely fixed on the loading floors and are easily accessible at the same time and the loading floors can be easily handled and arranged in the loading frame in a safe and space-saving manner.

This problem is solved by the invention by means of a transport system of the aforementioned type which is characterized in
that a locking system having interacting locking means for securely and releasably locking the loading floor for transport is provided in the loading frame on the floor supports and/or posts and on each or the loading floor;
that the loading floor comprises fastening elements for at least one cargo securing means for securing cargo to be transported on the loading floor; and
that the cargo can be placed on the loading floor outside of the cargo area and can be fixed by means of the cargo securing means for transport before the loading floor is placed in the loading frame.

The transport system according to the invention is to advantage in that it allows reaching increased transport safety as well as increased economic efficiency in the transport of cargo, more particularly general cargo, with transport vehicles, more particularly trucks, railway cars or containers. At the same time, the burden on the driver of the transport vehicle and the transport vehicle loading times can be considerably reduced by shifting the transport securing measures for the cargo from the interior region of the cargo area body to the outside of the cargo area body and from the driver to local loading staff. Therein, the loading floor comprises fastening elements in it or on it in an advantageous manner, said fastening elements being provided for at least one cargo securing means for securing cargo to be transported on the loading floor during transport. As a result, it is possible to have local loading staff load a loading floor with the cargo to be transported and secure it for transport already before the arrival of the transport vehicle. On arrival of the transport vehicle, all that still needs to be done is inserting the completely and safely loaded loading floor into the loading frame arranged in the cargo area body from outside of the cargo area body and securely locking the inserted loading floor in its transport position for transport by means of the locking system having the interacting locking means, said locking system being provided on the floor supports and the loading floor. Therein, the driver's responsibility can be restricted to checking whether the goods are secured for transport and to actuating the mechanism for locking the loading floor in the loading frame and/or checking whether the loading floor is locked in the loading frame.

Appropriately, the transport system according to the invention is used for a multi-level loading system because, therein, its advantages will take particular effect. For non-multi-level loading purposes, however, it is also possible to arrange the loading frame and/or the loading floor supports at the height of the floor of the cargo area of the transport vehicle and to arrange one or a plurality of loading floors on the floor of the cargo area of the transport vehicle in a removable manner. This, too, is to advantage in that it allows having local loading staff load the loading floor with the cargo to be transported already before the arrival of the transport vehicle, and secure it for transport and then inserting the loading floor with the cargo secured thereon into the transport vehicle and to secure it therein.

The invention is to further advantage in that a transport vehicle that is equipped with the described transport system remains suitable for conventional use without having to be modified wherein, with such a transport vehicle, cargo or pallets supporting said cargo are first loaded into the cargo area of the vehicle and are then manually secured on the spot in the cargo area of the vehicle. Therein, it is also possible to use loading beams and/or cargo securing beams that are suitable for being mechanically coupled to the posts of the loading frame, unless the vehicle already comprises other conventional mounting rails for conventional loading beams and/or cargo securing beams.

As a supplement, the transport system according to the invention can comprise conveyor equipment which is formed in a suitable manner for receiving and fixing one or a plurality of loading floors and which transport the loading floors, for example, within halls and/or grounds of a freight forwarding company or production shop, wherein this can also be achieved without a driver and under the control of a computer. Application, for example, on freight airports is also possible therein.

To utilize the space in an improved manner, different loading floors can be inserted into the loading frame at different heights according to their specific space requirements by designing the loading frame such that the floor supports are vertically adjustable on the posts. Therein, the vertical adjustment of the floor supports can be achieved manually or by means of a power drive, such as a hydraulic or pneumatic piston-cylinder unit or a motor-driven spindle. The shape of the floor supports may vary; for example, the floor supports can be designed as an isolated support or as a support strip or also as a guide strip.

The fact that the floor supports can, preferably, be removed from the posts also contributes to a good capability of the transport system to be adapted to changing requirements.

A particularly safe and economic embodiment of the invention can be achieved if the locking system can be used to establish a self-acting or remote-controlled locking of the loading floor in its transport position in the loading frame and an intentional unlocking of the locking system can be made manually or in a remote-controlled manner.

A preferred further development provides that the locking system can be actuated by a loading device that inserts the loading floor into the loading frame and removes the loading floor from the loading frame, more particularly by a forklift truck or a crane. As a result, manual actuating interventions that are time-consuming and give rise to the risk of errors are avoided.

In a further embodiment, it is provided that the locking system can be actuated by stressing/relieving and/or inserting/mounting or removing the loading device.

To reach a high protection against detachment in a self-acting manner, it is suggested that the locking system can, in addition, be disabled in a positive or non-positive manner in locking direction by relieving and/or removing the loading device.

To support locking disabling, the locking system can, appropriately and additionally, be disabled in a positive manner by relieving and/or removing the loading device by means of an elastic element, such as a spring or a gas shock absorber.

Therein, the locking system can be disabled by relieving and/or removing the loading device by means of preloading force, such as spring force.

An alternative to the embodiment described above provides that the locking system can be manually actuated both for locking and unlocking the loading floor. This allows a technically simple solution which, on the other hand, requires only a little more operating effort.

A concrete preferred embodiment of the locking system of the transport system provides that, at each of its corners which are each interacting with a floor support, the loading floor comprises a securing arm for securing the loading floor in the loading frame, wherein said securing arm can be swiveled in and out or pushed in and out and can be brought into and out of engagement with an opening in the associated floor support or post. As a result, a high functional reliability and a long durability are achieved with a construction that can have a relatively simple, compact and stable design from a technical point of view.

To allow easy and safe moving as well as inserting and removing of a loading floor, it is, preferably, provided that the loading floor comprises at least one receptacle for the fork of a forklift truck and/or means for fastening lifting accessories of a lifting appliance or crane. Therein, the receptacle for the fork, preferably, comprises a lateral oversize which allows a certain lateral displacement of the loading floor on the fork, with the result that the insertion of the loading floor into the loading frame is facilitated.

A further embodiment provides that the loading floor is designed like a frame, for example, to receive containers which do not require any continuous loading floor surface. This allows forming the loading floor in a particularly easy and material-saving manner. Furthermore, there is the possibility that the loading floor is equipped with one or a plurality of ball or roller tracks, for example, to be able to move containers or other cargo with a flat bottom side easily and quickly onto and from the loading floor wherein, preferably, further roller or ball tracks are arranged upstream or downstream of the loading floor while the latter is loaded and unloaded. In order to fix the cargo on such a loading floor, the rollers or balls of the roller or ball tracks can, appropriately, be lowered below a loading level of the loading floor.

Furthermore, it is suggested that the loading floor is designed with walls, if necessary also with a roof or cover, as cargo securing means. Therein, at least one wall can be designed as a door or flap in order to be able to make the interior region of the containers thus formed accessible. With this loading floor which is designed as a container that is open at the top or closed completely, sensitive goods can be transported in a protected manner. It is also conceivable to equip this container-like loading floor with fastening elements that are suitable for transport in a freight plane, in order to allow combined transport by ground and by air without any problems. As a matter of course, it is, therein, provided that the container-like loading floor is so stable in itself that it can be transported in a harmless manner both in a loading frame of a ground transport vehicle and in a freight plane.

An embodiment of the transport system provides that the loading frame is mounted in the cargo area of the transport vehicle in a detachable and removable manner. Therein, separate loading frame posts or partial loading frames can, for example, be standing on the cargo area floor and be connected to the cargo area body and/or the vehicle frame in a detachable manner by means of securing means. In addition, the loading frame can be designed such that it can be re-adjusted in its dimensions. Thereby, the loading frame can be adjusted more easily to the cargo area bodies of different transport vehicles. Moreover, this allows loading complete loading frames with a plurality of loading floors that secured for transport in advance. The complete loading frame can then be inserted into the cargo area body and secured there by means of suitable securing means for transport as a whole; this also results in considerably reduced efforts for the driver of the transport vehicle. Therein, a complete loading frame of a partial loading frame can, for example, be inserted into the cargo area of the transport vehicle from the latter's side or rear by means of a forklift truck and removed from the cargo area to the side or to the rear. Therein, fastening means for lifting accessories of a lifting appliance on the loading frame posts also allow inserting a complete loading frame into the cargo area from above and removing it from the cargo area to the top provided the cargo area can be opened on its upper side.

Therein, it is also possible that the loading frame is formed by a plurality of partial loading frames that can be individually detached and removed. Hereby, smaller and more light-weight units are formed, which can be handled more easily.

In order to be able to accommodate and transport and store the loading frame or the partial loading frames in a space-saving manner if said loading frame or partial loading frames are not in use and in order to be able to adjust a transport vehicle quickly to different requirements, it is provided that the loading frame or the partial loading frames thereof can be folded up and/or taken apart in their empty state.

As an alternative, the cargo area can be designed with a securely mounted loading frame or as a loading frame. Although the embodiment with a securely mounted loading frame is less variable, it allows a simple construction of the loading frame. If the cargo area is designed as a loading frame, it also allows facilitating a particularly simple construction which gets on with a few parts and comprises a low intrinsic weight. Therein, the cargo area that is designed as a loading frame can be securely mounted or can, as an alternative, be removable from the transport vehicle and be mountable to the transport vehicle as a whole or in part.

In order to achieve a construction that is, on the one hand, simple and, on the other hand, stable, it is preferably provided in an embodiment that at least a part of the posts of the loading frame is formed by stakes or walls or wall reinforcements of the cargo area body of the transport vehicle. Hereby, parts that already exist on the transport vehicle are also, advantageously, used for the loading frame. If the transport vehicle comprises stakes that serve as posts, then the stakes can, preferably, be divided and/or displaced and/or removed in order to be able to use the transport vehicle in a versatile manner and to load and unload said transport vehicle easily.

A further embodiment of the invention provides that a floor of the cargo area itself is, at least in some of its regions, formed by one or a plurality of removable loading floors. As a result, the bottommost loading level of a transport vehicle is also incorporated in the system according to the invention and a further increase in the economy of space is achieved. In this case, the cargo area body does not need its own floor any longer because the loading frame of the partial loading frames can then be directly placed on a bearing part of the chassis frame of the transport vehicle, such as the longitudinal chassis beams thereof.

In order to achieve a high stability and dynamic loading capacity of the loading frame, it is, therein, to advantage if the posts of the loading frame comprise means for connecting posts to each other and/or to a cargo area body and/or to a vehicle frame. Therein, the connection of the posts to each other can be achieved via the cargo area body, for example, by bracing and/or fastening the loading frame posts between the cargo area floor, the cargo area ceiling and/or the cargo area walls. For the purpose of a simple fastening possibility, it can be provided that the loading frame posts comprise means on their bottom side and/or on their outside and/or on their upper side for respectively fastening them to complementary fastening means on the cargo area floor and/or on the cargo area ceiling and/or on the cargo area walls, wherein said means can be used to ensure that the loading frame can be easily and securely fixed in the cargo area body for transport.

In each of its embodiments of the loading frame, the loading frame posts can be connected by means of an auxiliary frame to increase the stability of said loading frame, wherein said auxiliary frame can, for example, consist of struts extending horizontally and/or diagonally between the loading frame posts. As a matter of course, the parts of the auxiliary frame are, therein, arranged such that they do not impair the insertion and removal of the loading floors, for example, on one or two lateral surfaces of the loading frame or on a rear side of the loading frame.

In order to form, in particular, continuous or even drivable loading platforms from a plurality of loading floors that are neighboring each other, it is suggested that intermediate or filler pieces can be mounted between loading floors that are neighboring each other. For example, the intermediate or filler pieces can be loosely insertable or removable from the loading floors or retractable from the loading floors.

In order to be able to securely and safely fix cargo on the loading floor, it is provided that the fastening elements of the loading floor which are intended for fastening the securing means are formed by floor regions that are reinforced in their material and/or shape and/or by fastening elements that are integrated in the loading floor. Therein, the fastening elements are, for example, formed by profile rails that are, in particular, U-shaped and are arranged such that their base faces upwards, wherein the base comprises a series of recesses in which the securing means can be optionally fastened. At the same time, the U-rails advantageously provide for a high bending strength of the loading floor, this making it also suitable for heavy loads, wherein a corresponding stability of the loading frame is assumed. In order to ensure a flat cargo-preserving surface of the loading floor, the surface of the base of the U-shaped profile rails is, appropriately, arranged in the same plane as a loading surface of the loading floor.

In order to be able to accommodate loading floors that are not loaded, held available at a loading and unloading station or carried along in a transport vehicle in a space-saving manner, it is suggested that the loading floor is provided with a stepped edge or a chamfered edge for the purpose of stacking a plurality of unloaded loading floors into each other. This facilitates stacking empty loading floors one on top of the other in a reliable manner and in a manner that requires little room, wherein a loading floor stack can be stored or transported both within a loading frame and outside thereof.

Furthermore, good space utilization can be achieved if the surface measure of the loading floor corresponds to an integer multiple of the surface measure of a standardized transport pallet, plus a play of movement required for loading and unloading. As a result, it is also possible to fix a plurality of standardized transport pallets at the same time, which are already secured for transport and can then be very quickly and jointly loaded by means of correspondingly powerful forklift trucks or lifting appliances.

In order to be able to insert the loading floor more easily into the loading frame and in order to be able to adjust the loading floor exactly to the distance of the posts of the loading frame with the floor supports, it is possible that the dimensions of the loading floor can be changed by means of telescopic adjustment in at least one horizontal extension direction.

Furthermore, the loading floor and/or the loading frame can comprise guiding and centering means for supporting the insertion of the loading floor into the loading frame, such as introducing chamfers or stops. Such guiding and centering means make a forklift truck driver's or crane operator's work of inserting the loading floor into the loading frame easier and prevent damage caused by mutual abutting on each other. The guiding and centering means can be securely mounted or adjustable. Moreover, they can form parts of the locking system described above and/or serve as intermediate or filler pieces between neighboring loading floors.

In order to prevent increased wear and tear and loud noise during insertion of the loading floor into the loading frame and during removal of the loading floor from the loading frame, the invention suggests that the floor supports and/or the loading floor comprise sliding elements at their contact surfaces. Therein, the contact elements are, preferably, exchangeable. A well-suitable preferred material for sliding elements is plastic material.

As a supplement, the loading floor can be provided with slide bars made of plastic at its lateral edges in order to prevent damage if the loading floor and the loading frame posts contact each other while the loading floor is inserted into the loading frame and the loading floor is removed from the loading frame.

As a matter of principle, it is possible to make use of known and traditional securing means for fixing the cargo on the loading floor, such as tension belts or nets or the like. Preferably, however, it is provided for the transport system according to the invention that the cargo securing means consists of at least two, if necessary even more, tensile tractive means, the particular associated tensioning devices and connecting means for connecting the tractive means to the fastening means of the loading floor and that each tractive means can be tensioned separately via the associated tensioning device. Therein, all tractive means, preferably, engage a tractive knotted plate in a joint, more preferably a hinged manner wherein, in the cargo securing condition, the arrangement of the tractive knotted plate is provided above the loading floor on the upper side of the cargo. Hereby, the cargo can be fixed on the loading floor with a single cargo securing means such that it is secured in all directions, with the result that no slipping of the cargo is to be expected on the loading floor, even in case of strong accelerations, such as brake applications or cornering of the transport vehicle.

### BRIEF DESCRIPTION OF THE DRAWINGS

Exemplary embodiments of the invention will be illustrated below by means of a drawing. In the drawing,

FIG. 1 is a schematic view of a transport system using the example of a road semitrailer during a loading process;

FIG. 2 is a diagonal front view of a single partial loading frame as a part of the transport system, with vertically adjustable floor supports and a loading floor that is carrying cargo;

FIG. 3 is a diagonal top view of a single loading floor;

FIG. 4 shows a detail of the loading frame at the connection point between the loading floor and the loading frame posts by means of a floor support;

FIG. 5 is a diagonal top view of the loading frame of FIG. 2 during the insertion of a second loading floor;

FIG. 6 is a schematic view of the transport system using the example of a truck in a still unloaded condition;

FIG. 7 is a diagonal perspective bottom view of a loading floor, along with a detail of a loading frame and a locking system;

FIG. 8 is an enlarged representation of three details A, B and C of FIG. 7;

FIG. 9 is a diagonal front view of a further single partial loading frame with an auxiliary frame;

FIG. 9A is an enlarged detail of a corner portion of the loading frame of FIG. 9;

FIG. 10 is a vertical sectional view of a floor support arranged on a post of a loading frame in locked condition;

FIG. 11 is a vertical sectional view of the post with the floor support of FIG. 10, now in unlocked condition;

FIG. 12 shows a cargo securing means of the transport system with a tractive knotted plate and four tensioning means;

FIG. 13 is a partial top view of a profile rail of the loading floor as a fastening means for cargo securing means;

FIG. 14 is a partial longitudinal sectional view of the profile rail through a recess; and

FIG. 15 shows a loading floor with cargo fixed thereon by means of the cargo securing means according to FIG. 12.

### DESCRIPTION OF THE PREFERRED EMBODIMENTS

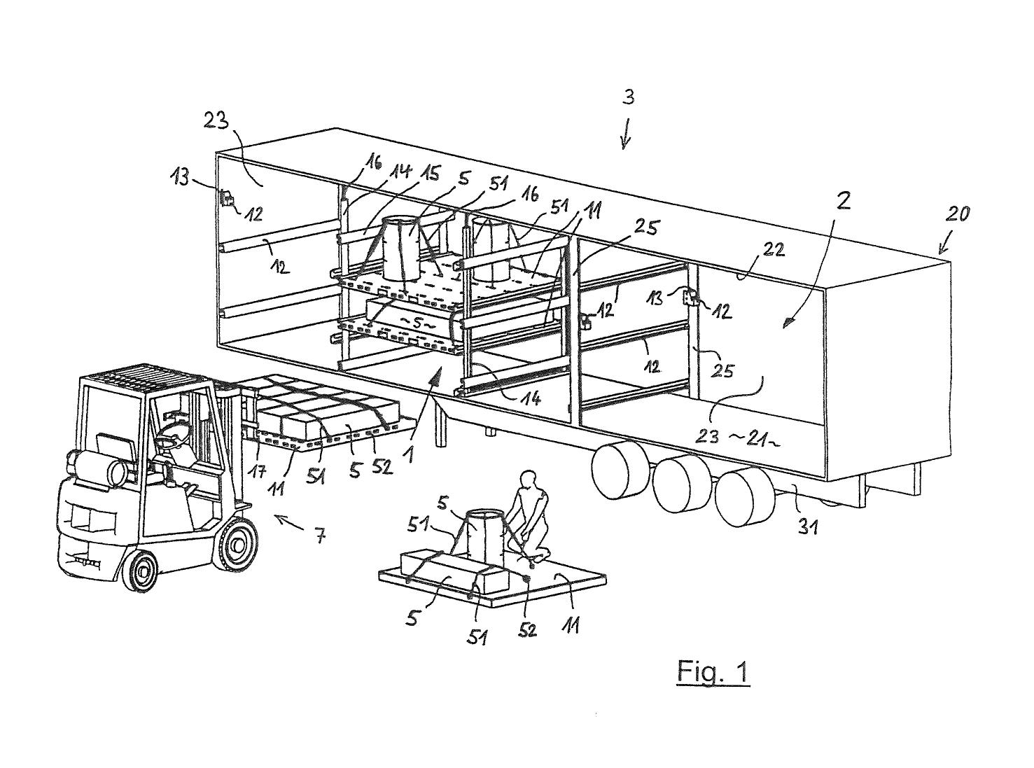

FIG. 1 is a schematic view of a loading process of a transport vehicle 3 that is equipped with the transport system according to the invention described above, shown with a road semitrailer in the illustrated instance, the cargo area body 20 of which has a cargo area 2 and is opened on its side for loading. The transport vehicle 3 has a vehicle frame 31 on which rests a cargo area floor 21. Cargo area walls 23 the side wall of which that is facing the viewer is opened or removed in the illustrated instance are provided on the lateral and front sides. At its upper side, the cargo area 23 is closed by a cargo area ceiling 22.

In this example, a loading frame 1 is arranged in the cargo area 2, said loading frame 1 having three partial loading frames with different designs to show different embodiments; in practice, a transport vehicle 3, appropriately, has uniform partial loading frames. In the illustrated instance, two loading floors 11 have already been inserted into the loading frame 1, said loading floors 11 being loaded with cargo 5 which is fixed on the loading floor 11 with securing means or apparatus 51 in a manner secure for transport.

A third loading floor 11 is currently located on the fork of a forklift truck that is used as a loading device 7. This third loading floor 11 is also loaded with cargo 5 and has already been secured for transport by means of belt-type securing means 51 which are connected to the loading floor 11 via the fastening means or arrangement 52. Therein, the securing means 51 can also be designed as plastic wrapping, transport nets, tensioning belts, and similar securing means. The loading floor 11 is equipped with receptacles 17 for the fork of the forklift truck 7 on its front face and can, therefore, be lifted safely and inserted into the loading frame 1.

In the meantime, loading staff provides a fourth loading floor 11 that has already been loaded with cargo 5 and has been deposited in front of the transport vehicle 3 with securing means 51 to fix the cargo 5 for transport. After the cargo securing means 51 have been applied, the fourth loading floor 11 can also be inserted into the loading frame 1. The different embodiments of the partial loading frames in FIG. 1 are shown to illustrate the manifold potential embodiments of the transport system and, essentially, differ in the floor supports 12 carrying the loading floors 11 and in fastening elements 13 for mounting the floor supports 12 to one or a plurality of cargo area walls 23 and/or to separate loading frame posts 14 that are or can be mounted in or to the cargo area body 2.

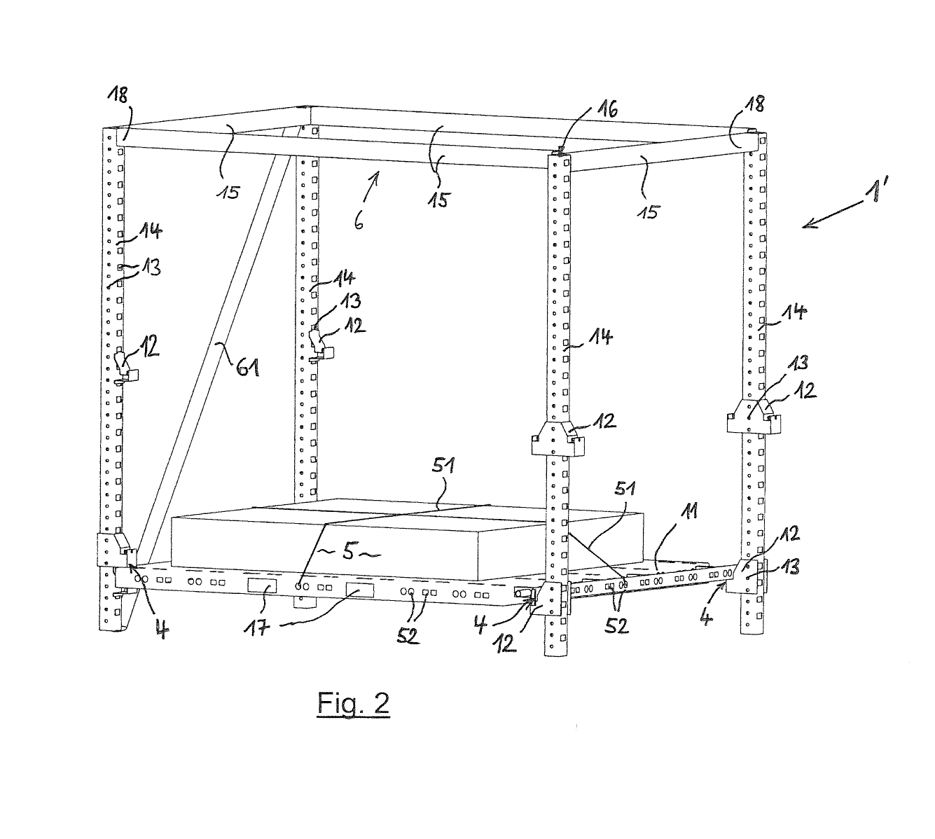

FIG. 2 shows an individual partial loading frame 1′ which comprises four loading frame posts 14 to which the floor supports 12 are mounted in a vertically adjustable manner via the fastening elements 13. A loading floor 11 is placed onto the floor supports 12 and locked securely for transport with locking means of a locking system 4. Cargo 5 which, in the illustrated instance, is fixed by means of two cargo securing means 51 that are arranged criss-cross has been placed on the loading floor 11, said cargo securing means 51 being fastened to or in the loading floor 11 at matching selected fastening means 52.

To connect the loading frame posts 14 to each other, the partial loading frame 1′ is provided with an auxiliary frame 6 which, in the illustrated instance, comprises horizontal connecting struts 15 and one diagonal strut 61. The shown partial loading frame 1′ can also be loaded with cargo 5 outside of the cargo area of the transport vehicle, wherein said cargo 5 can be secured for transport by means of the cargo securing means 51 and the fastening means 52. Further loading floors 11 that have been completely loaded and secured can be placed onto further floor supports 12 and can be loaded as a whole in the manner of a shelf and then be provided with transport securing devices for the individual cargo pieces. Once the complete partial loading frame 1′ has been completely loaded and the cargo has been secured, the partial loading frame 1′ can, as a whole, be lifted by a lifting appliance, for example, via the means 18 for fastening lifting accessories for lifting appliances, and be inserted into a cargo area from above.

If, however, the partial loading frame 1′ is, alternatively, permanently installed in the cargo area body 20 in the embodiment shown in FIG. 1, one or a plurality of further loading floors 11 can be variably placed onto the further floor supports 12 at the same or a further loading station for the transport vehicle 3, wherein said floor supports 12 can be suitably adjusted to their vertical position.

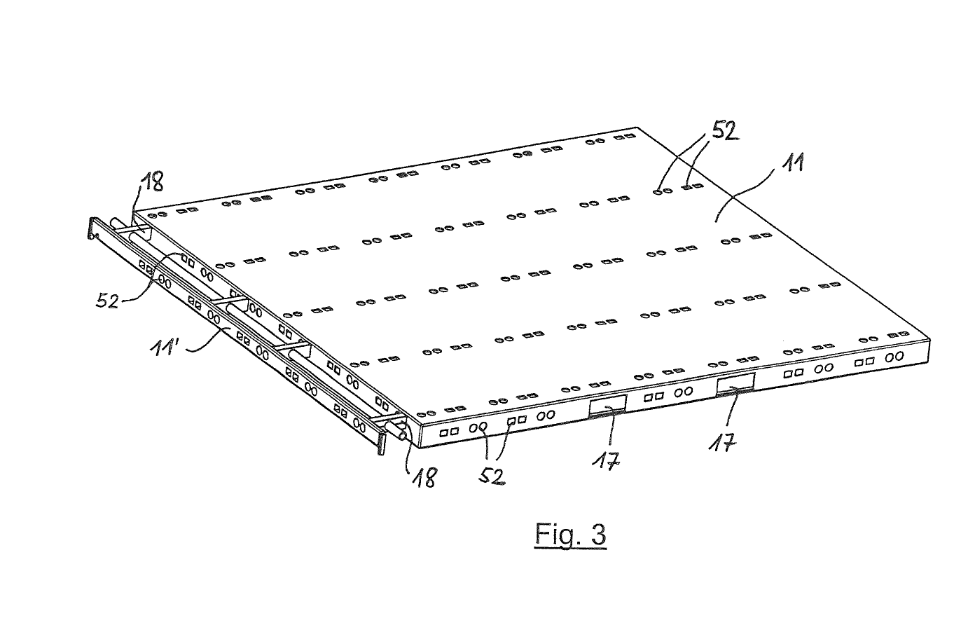

FIG. 3 is a diagonal top view of a single loading floor 11 with the different fastening means 52 for the cargo securing means 51 for cargo 5, none of which are shown in the illustrated instance. The loading floor 11 can be lifted via the receptacles 17 for receiving the fork of a forklift or stacker truck or via the means 18 for fastening lifting accessories for lifting appliances and inserted into the loading frame.

The edge part 11′ of the loading floor 11 that is the left one in FIG. 3 can be displaced in relation to the remaining loading floor 11 by telescopic adjustment in order to be able to compensate for tolerances of the loading frame and the floor supports mounted thereto in a non-coercive manner. The two receptacles 17 for the fork of a forklift truck are visible on the front edge of the loading floor 11.

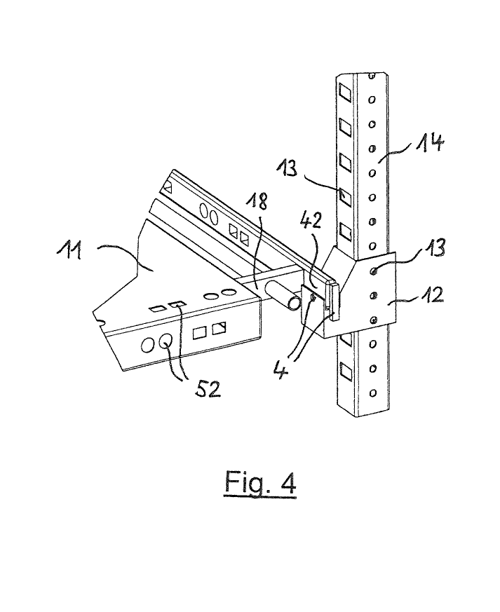

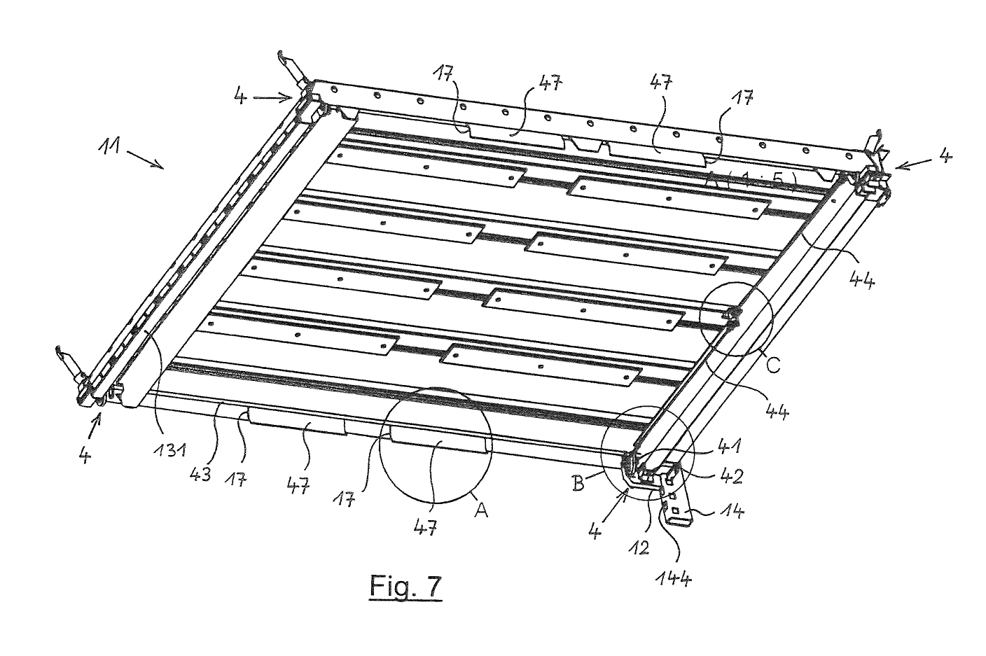

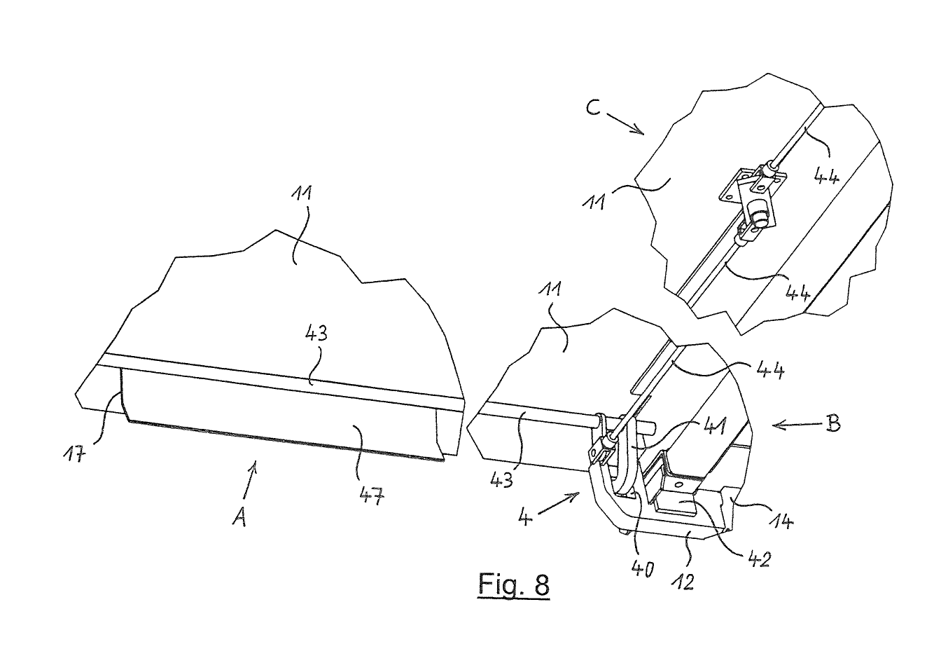

When the loading floor 11 is inserted into the loading frame 1, as shown in FIG. 4, the loading floor 11 is placed onto the floor supports 12 with feet 42 provided at its corners and is securely fixed there for transport by means of retaining means or elements of the locking system 4. These retaining means of the locking system 4 can, for example, comprise manually fittable fastening bolts or pins as shown in FIG. 4; but they can also be designed as locking elements of a different form, which can be locked and/or unlocked manually, by remote control or in a self-acting manner. A corresponding example will also be illustrated below by means of FIGS. 7 and 8.

The insertion of the loading floor 11 into the loading frame 1 or partial loading frame 1′ and the placement of the loading floor 11 onto the floor supports 12 at the exact position can be facilitated by means to support the positioning accuracy, such as for example introducing chamfers, stops, conical studs, and the like wherein, by way of example, an introducing chamfer is shown in FIG. 4 on the side of the floor support 12 that faces the loading floor 11.

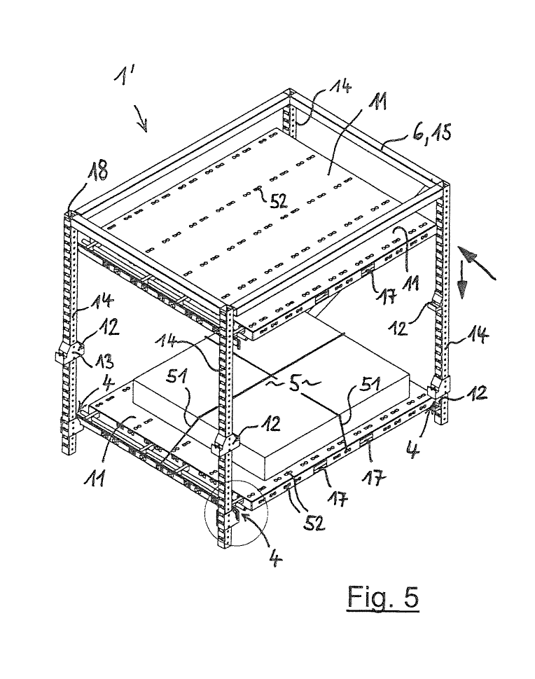

The sequence of insertion of a further loading floor 11 into a partial loading frame 1′ is once shown in FIG. 5 in a diagonal top view. According to the first upper motion arrow, the upper new loading floor 11 that is to be inserted and is unloaded in the illustrated instance is, initially, introduced between the posts 14 of the partial loading frame 1′ in an essentially horizontal direction and is then lowered in an essentially vertical direction according to the second lower motion arrow until it sits on the associated floor supports 12 which were positioned and fixed at the suitable height beforehand. After the loading floor 11 has been locked to the floor supports 12, the partial loading frame 1′ is ready for transport.

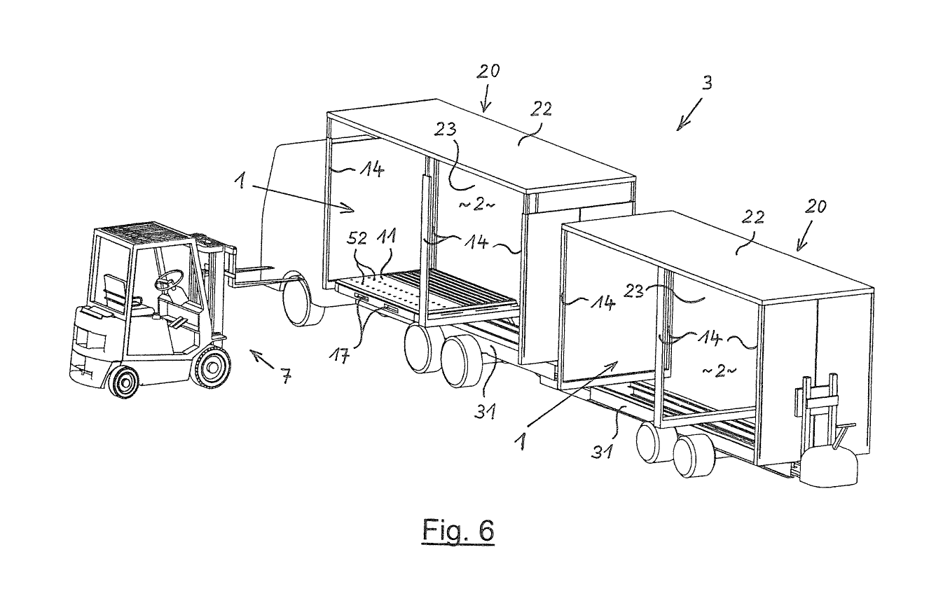

Similar to FIG. 1, FIG. 6 is a perspective view of a further example of the transport system, in the illustrated instance with a transport vehicle 3 in the form of a truck including a tractor and a trailer. Both parts of the transport vehicle 3 each have a cargo area body 20 with a cargo area 2 which is delimited by cargo area walls 23 on its sides and by a cargo area ceiling 22 on its top. As is shown at the tractor, the cargo area ceiling 22 can be designed as an elevating roof to facilitate loading and unloading.

A permanently mounted loading frame 1 which can be fitted with loading floors 11 in the type and manner described above is provided in each cargo area 2.

A special feature of the transport vehicle 3 shown here is that the tractor and the trailer do not comprise their own cargo area floor; each cargo area floor is rather formed by the bottommost loading floors 11. The bottommost cargo area floors 11 can be removed from the cargo area 2, just as are further cargo area floors. Hereby, the cargo area body 20 of the transport vehicle 3 is simplified in its construction and the weight of the trans-port vehicle 3 is somewhat reduced, this advantageously resulting in a higher useful load.

As has already been described above, the loading frames 1 each have vertical posts 14 here as well, to which floor supports (not shown) can be mounted, wherein a loading floor 11 can be placed on each of said floor supports with its four corners. Therein, the particular bottommost loading floors 11 forming the cargo area floor can, in addition, rest on longitudinal chassis beams of the vehicle frame 31 of the transport vehicle 3 so that the load can be dissipated in a favorable manner.

The loading floor 11 that is the only one shown in FIG. 6 again has two receptacles 17 for the fork of a forklift truck on its front side facing outwards, said forklift truck forming the loading device 7 in the illustrated instance. On its upper side, the loading floor 11 has the fastening means 52 for fastening the cargo securing means which are used to secure cargo present on the loading floor 11.

FIG. 7 is a perspective bottom view of a loading floor 11 along with a locking system 4 wherein the loading floor 11 can be automatically fixed by means of said locking system 4 when it is inserted into a loading frame in relation to said loading frame, said insertion being achieved by means of a loading device, which is a forklift truck in the illustrated instance, said loading frame only being shown by means of a detail of a loading frame post 14, and wherein the loading floor 11 can be automatically detached by means of said locking system 4 when it is removed from the loading frame.

Each corner of the rectangular loading floor 11 is provided with a foot 42 each of which interacts with a floor support 12 which is mounted to the loading frame post 14, as is shown by way of example at the right rearward corner of the loading floor 11. For the purpose of fixing the loading floor 11 to the floor supports 12 in a detachable manner, the locking system 4 has a swiveling securing arm 41 at each corner of the loading floor 11, said securing arm 41 having the form of a hook in the illustrated instance. Two forward and two rearward securing arms 41 are each mounted on a common shaft 43 in a non-rotatable manner, said shaft 43 being mounted on the loading floor 11 in a rotatable manner. Two flaps 47 each are connected to each shaft 43 in a likewise non-rotatable manner, wherein the flaps 47 each cover a fork receptacle 17 of the loading floor 11.

When the fork of a forklift truck is introduced into the fork receptacles 17, the flaps 47 are automatically swiveled upwards by approximately 90°, this effecting a corresponding swiveling of the securing arms 41, i.e., from their locking position to their unlocking position. In this unlocking position, the loading floor 11 which has now been detached from the loading frame can be lifted and removed from the loading frame.

When being inserted into the loading frame, a loading floor 11 is, vice versa, automatically locked with said loading frame by pulling the fork of the forklift truck out of the fork receptacles 17. As a result, the flaps 47 return to their basic position which is shown in FIG. 7 under the effect of gravity, if necessary supported by spring force, whereby a rotation of the shaft 43 and a corresponding swiveling of the securing arms 41 is effected in locking direction. As a result, the securing arms 41 are brought into engagement with the associated floor supports 12 and secure the loading floor 11 against undesired and harmful vertical movements in relation to the loading frame.

In order to simultaneously actuate all of the four securing arms 41 of the locking system 4 even if nothing but the flaps 47 on a longitudinal side of the loading floor 11 are actuated, transmission rods 44 providing for a synchronous adjustment of all securing arms 41 are arranged between the forward and rearward securing arms 41.

In order to avoid wear and noise during insertion of the loading floor 11 into the loading frame and during removal of the loading floor 11 from the loading frame, the loading floor 11 is, in the illustrated instance, provided with sliding elements 131 extending on its two lateral edges, said sliding elements 131, for example, having the form of exchangeable plastic profiles.

FIG. 8 is an enlarged view of the three details A, B and C of FIG. 7, showing each of these details in enlarged representation and in an arrangement that is spatially matching from a functional point of view. Detail A shows one of the flaps 47 on one of the fork receptacles 17 of the loading floor 11, along with a section of the shaft 43 to which the flap 47 is connected in a non-rotatable manner.

Detail B shows the parts of the locking system 4 at one of the four corners of the loading floor 11. The hook-shaped securing arm 41 is connected to the end of the shaft 43 in a non-rotatable manner. In the locking position shown in FIG. 8, the securing arm 41 engages into a through hole 40 of the floor support 12 and secures the loading floor 11 in vertical direction in relation to the loading frame, said through hole 40 serving as a hook receptacle. At the same time, the foot 42 of the loading floor 11 that is provided at this corner of the loading floor 11 rests on the floor support 12 and is secured in horizontal direction in relation to said floor support 12 by appropriate mutually positive engagement means. The floor support 12 is connected to the loading frame post 14 in a detachable manner, said loading frame post 14 being visible in FIG. 8 in a small detail only.

Detail C finally shows a section of the transmission rods 44 which is used to couple the securing arms 41 of one of the longitudinal sides of the loading floor 11 to the securing arms 41 of the other one of the longitudinal sides of the loading floor 11 in terms of motion. This effects a synchronous actuation of all of the four securing arms 41 when nothing but the flaps 47 on one of the longitudinal sides of the loading floor 11 are actuated, although the fork of a forklift truck is always introduced into the fork receptacles 17 of the loading floor 11 only from one side thereof.

Instead of the shafts 43 and the transmission rods 44, it is also possible to use a control cable arrangement with the same function. Furthermore, it is possible to replace the swiveling securing arms 41 by locking bolts that are equivalent in their function and can be adjusted in axial direction.

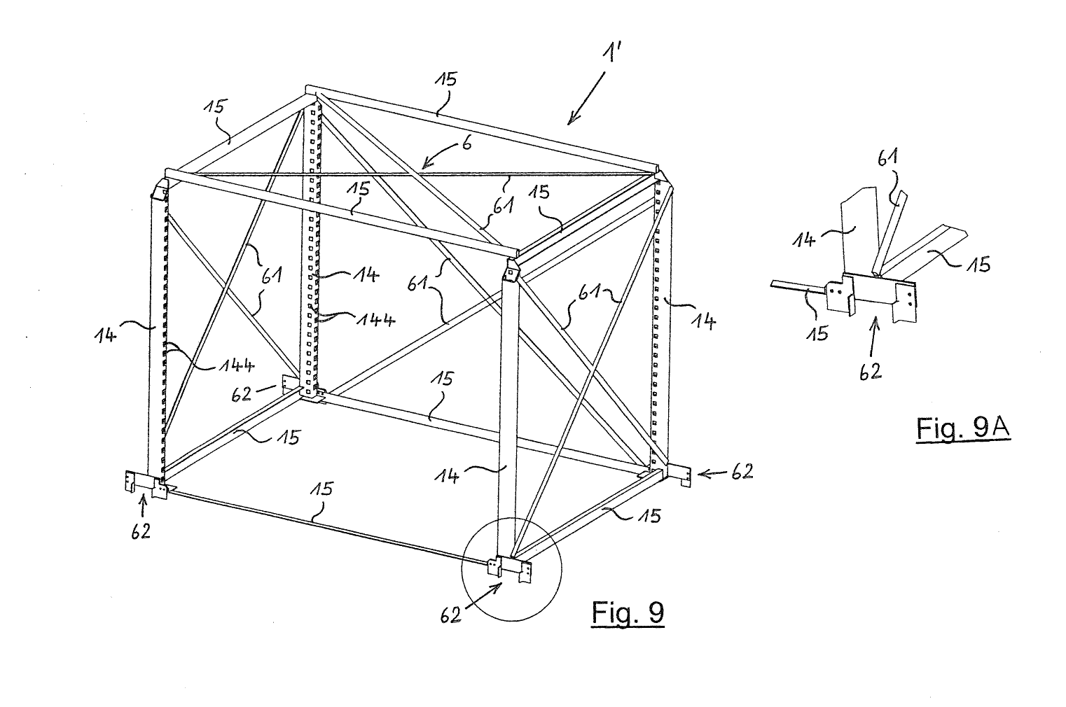

FIG. 9 shows an example of a partial loading frame 1′ which is connected to an auxiliary frame 6 to achieve a high torsional stiffness. The partial loading frame 1′ has the four vertical posts 14 which are each provided with through holes 144 arranged in a close pattern which are intended for mounting the floor supports (not shown). On each of the left and right as well as rear and upper sides, the posts 14 are connected to each other by means of horizontal connecting means or elements 15, i.e., angle profiles and U-profiles in the illustrated instance, and by means of diagonal struts 61. If the diagonal struts are only subject to tension, they can also be formed by belts or ropes or wires. Therein, the front side of the partial loading frame 1′, which faces the viewer, is kept open so that, from this side, the loading floors can be inserted and removed in opposite direction. The horizontal connecting means 15 which connect the lower ends of the posts 14 to each other can, at the same time, be used to distribute the load of the partial loading frame 1′, with the result that it is not necessary to dissipate the entire load via the lower end of each of the posts 14 at isolated points only.

A special feature of this partial loading frame 1′ is that it comprises a stake adapter 62 at the lower end of each of its posts 14. On its right, FIG. 9A shows one of the stake adapters 62 in an enlarged view as an encircled detail of the partial loading frame 1′. The stake adapters 62 are geometrically formed such that they can come into positive engagement with stakes of a vehicle body, whereby the partial loading frame can be fixed in a cargo area of the transport vehicle in a very easy manner. This partial loading frame 1′ can be used in a particularly favorable manner in transport vehicles which are equipped with swiveling sliding stakes which, for loading and unloading purposes, can be detached from the lower end of the vehicle body either from individual loading floors or from the complete partial loading frame 1′, swiveled away from the vehicle body and then displayed sideways. Vice versa, the partial loading frame 1′ standing on the loading platform of the transport vehicle can be fixed by displacing the stakes to a position corresponding to the stake adapters 62 and swiveling the stakes into the stake adapters 62 as well as locking the stakes to the body. Due to the positive engagement between the stake adapters 62 and the stakes, the partial loading frame 1′ can no longer move in horizontal direction. Any undesired vertical movement is either prevented by additional securing means or by the cargo area ceiling or limited to a harmless extent.

The auxiliary frame 6 described above is not applicable if a cargo area body of an associated transport vehicle provides for the mechanical stabilization of the loading frame 1 or partial loading frame 1′, for example, by the body, when being in its closed state, holding the loading frame 1 or partial loading frame 1′ in a positive and/or non-positive manner. This can, for example, be achieved by means of a body with folding and/or sliding and/or swiveling walls that are stable in themselves.

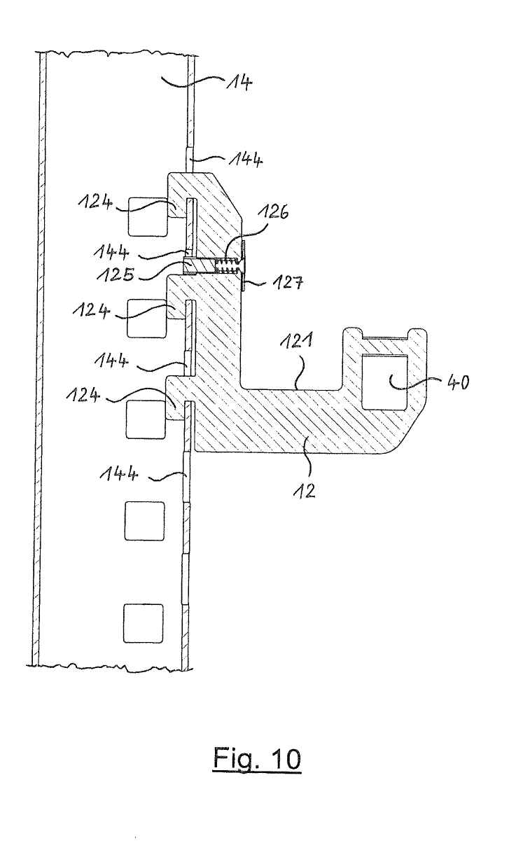

FIG. 10 is a vertical sectional view of a detail of the loading frame post 14 along with a floor support 12 that is retained thereon in a detachable manner. The loading frame post 14 has the through holes 144 which are arranged in a pattern and serve to receive suspension hooks 124 of the floor support 12, said suspension hooks 124 being arranged in a corresponding pattern. A locking stud 125 which is guided in the floor support 12 such that it is axially sliding in the sectional plane as well as vertically to the longitudinal direction of the loading frame post 14 serves to lock the floor support 12 in relation to the loading frame post 14. The locking stud 125 is loaded in its locking direction by means of a helical spring 126. Unless other outside forces act on the locking stud 125, said locking stud 125 takes its locking position shown in FIG. 10, in which position it engages into the associated through hole 144 of the loading frame post 14 above the central suspension hook 124. In this position of the locking stud 125, the floor support 12 can no longer be moved up to any considerable extent and, therefore, not be hung out of the loading frame post 14 either.

In its region that is facing away from the loading frame post 14, the floor support 12 has the foot rest 121 on which the associated foot 42 of the loading floor 11 (not shown) is supported in the inserted state. In the outer end region of the floor support 12, the securing arm receptacle is arranged in the form of the rectangular through hole 40 as part of the locking system 4.

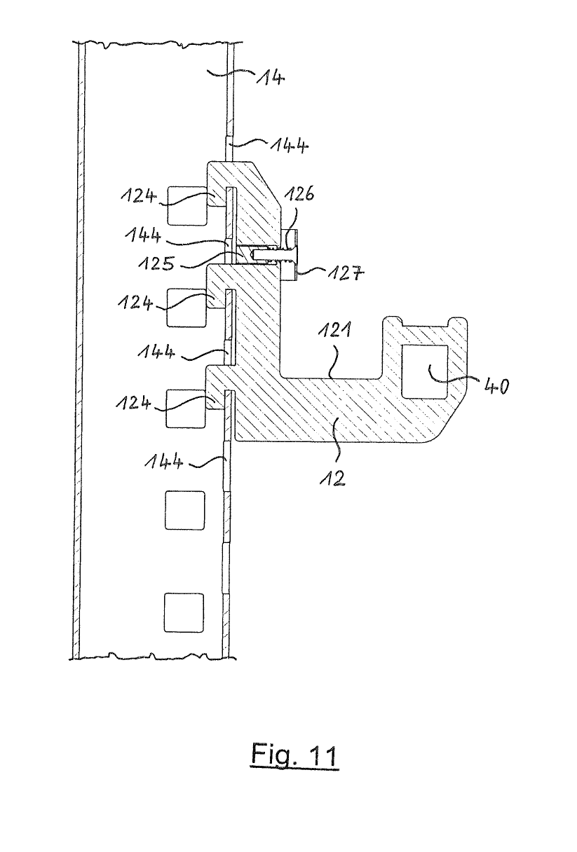

If it is intended to displace the floor support 12 on the loading frame post 14 or to remove said floor support 12 completely from said loading frame post 14, a grab handle 127 is used to move the locking stud 125 outwards, i.e., in a direction facing away from the loading frame post 14, against the force of the spring 126, until the locking stud 125 has been removed from the through hole 144, as this is shown in FIG. 11. In this position of the locking stud 125, the floor support 12 can be moved up in relation to the loading frame post 14 until the suspension hooks 124 can be pulled out through the through holes 144. The floor support 12 can then be reconnected to the loading frame post 14 at a desired different point thereof wherein, after the floor support 12 has been hung into the loading frame post 14, the locking stud 125 again automatically assumes its locking position shown in FIG. 10 by the effect of the spring 126.

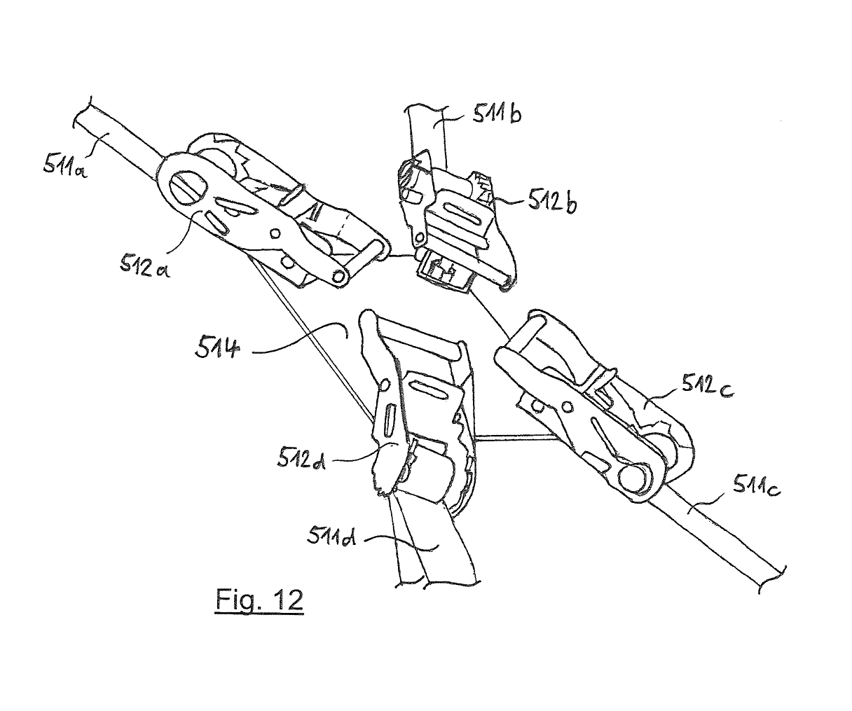

FIG. 12 shows an example of a cargo securing means 51 which comprises a tractive knotted plate 514, four tractive means or mechanisms 511a-d and four tensioning means or devices 512a-d. In the illustrated instance, the tractive means 511a-d are tension belts and the tensioning means 512a-d are ratchet tensioners which are connected to the tractive knotted plate 514 in a permanent or, more preferably, in an articulated manner. Therein, the tractive knotted plate 514 can be made of a relatively rigid material or also of a flexible material, for example, of a fabric-reinforced rubber mat.

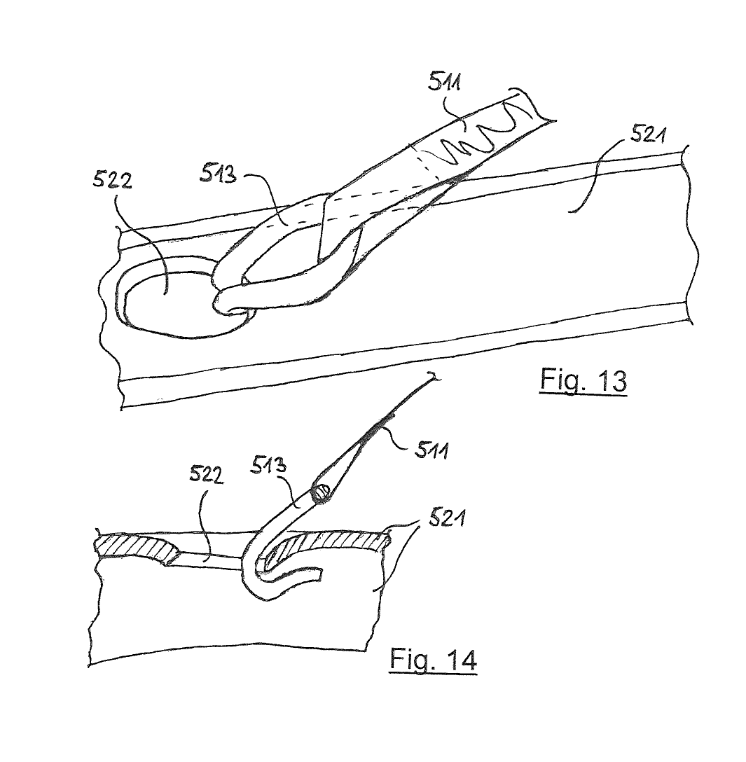

Furthermore, FIG. 13 is a top view and FIG. 14 a longitudinal sectional view of a profile rail 521 as a part of the loading floor 11, said profile rail 521 being U-shaped in its cross-section, wherein the loading floor 11 comprises a plurality of such profile rails 521 arranged in parallel to each other. The upward facing surface of the base of the U-shaped profile rail 521 is arranged in the same plane as a loading surface of the loading floor 11 which is, by the way, not shown here. The profile rail 521 serves to fasten the cargo securing means 51 and, for this purpose, has recesses 522 arranged at a grid spacing, with only one of these recesses 522 being visible in each of FIGS. 13 and 14. Herein, a tow hook 513 of the tractive means 511 can be safely hooked behind an edge of the recess 522 and transmit the tension force applied by the tensioning means 512 for cargo securing purposes, said edge of the recess 522 being flanged down or pressed through. Therein, the tow hook 513 is formed and bent such that it is adjusted to the shape of the recess 522, with the result that tractive forces can be reliably transmitted even at a steeper angle up to the perpendicular or beyond without there arising the risk that the tow hook 513 can detach from the recess 522 in an unintentional manner.

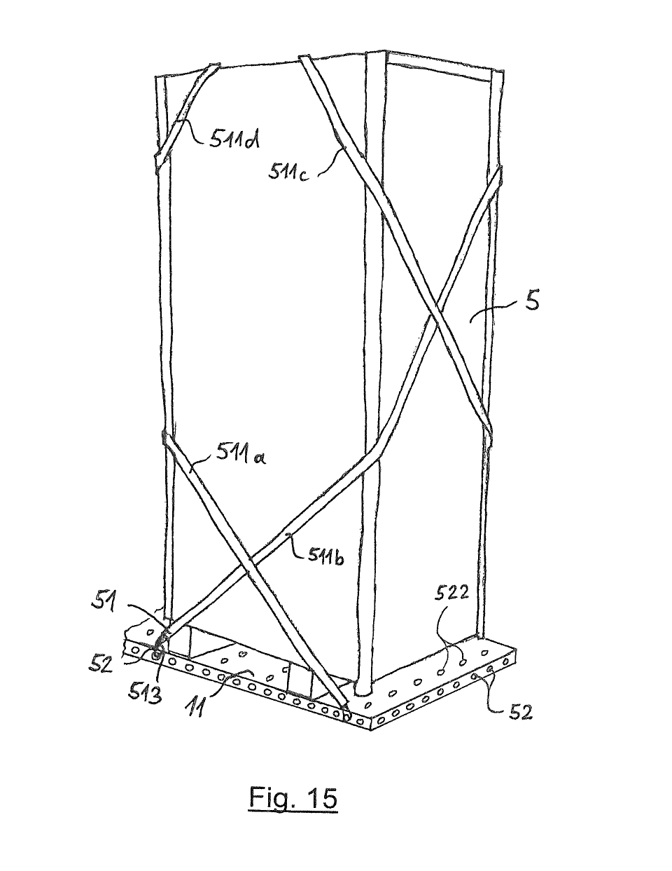

FIG. 15 shows the cargo securing means 51 according to FIG. 12 in the state where a cargo 5 is secured on a loading floor 11. Starting from the tractive knotted plate 514 (not visible here) that is arranged on top of the cargo 5, the tractive means 511 are arranged such that they extend criss-cross and diagonally and are each hooked into front-faced fastening means of the loading floor, said fastening means being drilled holes in the illustrated instance, with their lower end. If the holding angles of the tractive force are favorable, the tractive means 511, thus, only require little space while the cargo 5 is, at the same time, reliably fixed on the loading floor 11. Due to their central arrangement on the tractive knotted plate 514 on the upper side of the cargo 5, the tensioning devices 512 can be easily operated and checked for their tensioned state.

As is apparent from the foregoing specification, the invention is susceptible of being embodied with various alterations and modifications which may differ particularly from those that have been described in the preceding specification and description. Different components may be located in different ones of the two cubes and may be arranged on different faces of the two cubes as shown in a few exemplary embodiments in the drawings. Also, different voltages can be transformed and provided at different outlets than those described. The voltages can be transformed higher or lower from the inlet to the outlet receptacles. What is important is that the total weight of the various components is divided and distributed between the multiple pieces of the distribution center, which in the embodiments is shown as being two pieces, however, more than two pieces are also contemplated. It should be understood that I wish to embody within the scope of the patent warranted hereon all such modifications as reasonably and properly come within the scope of my contribution to the art.

List of reference symbols:

| Symbol | Description |
|---|---|
| 1 | Loading frame |
| 1′ | Partial loading frames |
| 11 | Loading floor |
| 11′ | Edge part |
| 12 | Floor support |
| 121 | Foot rest |
| 124 | Suspension hooks |
| 125 | Locking studs |
| 126 | Spring |
| 127 | Grab handle on 125 |
| 13 | Fastening elements for 12 |
| 131 | Sliding elements |
| 14 | Post of 1 |
| 144 | Through holes in 14 for 124 and 125 |
| 15 | Means for connecting 14 to 14 |
| 16 | Means for connecting 14 to 20 |
| 17 | Receptacles for fork of forklift truck |
| 18 | Lifting accessories for lifting appliances |
| 2 | Cargo area |
| 20 | Cargo area body |
| 21 | Cargo area floor |
| 22 | Cargo area ceiling |
| 23 | Cargo area walls |
| 25 | Cargo area posts |
| 3 | Transport vehicle |
| 31 | Vehicle frame |
| 4 | Locking system for 11 |
| 40 | Opening |
| 41 | Securing arm |
| 42 | Foot on 11 |
| 43 | Shaft |
| 44 | Transmission rods |
| 47 | Flaps on 17 |
| 5 | Cargo |
| 51 | Securing means for 5 |
| 511a, b, c, d | Tractive means |
| 512a, b, c, d | Tensioning device for 511a, b, c, d |
| 513 | Tractive means connection to 52 |
| 514 | Tractive knotted plate |
| 52 | Fastening means to 11 for 51 |
| 521 | Profile rail for 52 |
| 522 | Recess in 521 |
| 6 | Auxiliary frame for 1 |
| 61 | Diagonal struts |
| 62 | Stake adapter |
| 7 | Loading device |

1-33. (canceled)

34. A transport system comprising:
a loading frame disposed in or that can be brought into a cargo area of a transport vehicle and
at least one loading floor that can be inserted in the loading frame and removed from the loading frame,
wherein the loading frame comprises posts and floor supports mounted thereon for receiving the at least one loading floor,
wherein a locking system having an interacting locking arrangement to securely and releasably lock the loading floor for transport is provided in the loading frame on the floor supports and/or posts and on each loading floor,
wherein the loading floor comprises fastening elements for at least one cargo securing device to secure cargo to be transported on the loading floor, and
wherein the cargo is arranged to be placed on the loading floor outside of the cargo area and is arranged to be fixed by the cargo securing device for transport before the loading floor is placed in the loading frame,
wherein the loading floor and/or the loading frame comprise guiding and centering structures to assist in supporting the insertion of the loading floor into the loading frame.

35. The transport system according to claim 34, wherein the guiding and centering structures comprise chamfers or stops.

36. The transport system according to claim 34, wherein the guiding and centering structures are securely mounted or adjustable.

37. The transport system according to claim 34, wherein the guiding and centering means form parts of the locking system.

38. The transport system according to claim 34, wherein the guiding and centering structures serve as intermediate or filler pieces between neighboring loading floors.

39. The transport system according to claim 34, wherein the floor supports are vertically adjustable on the posts.

40. The transport system according to claim 34, wherein the floor supports are removable from the posts.

41. The transport system according to claim 34, wherein the locking system is arranged to establish a self-acting or remote-controlled locking of the loading floor in its transport position in the loading frame and an intentional unlocking of the locking system is arranged to be made manually or in a remote-controlled manner.

42. The transport system according to claim 41, wherein the locking system is arranged to be actuated by a loading device that inserts the loading floor into the loading frame and removes the loading floor from the loading frame.

43. The transport system according to claim 42, wherein the locking system is arranged to be actuated by stressing/relieving and/or inserting/mounting or removing the loading device.

44. The transport system according to claim 42, wherein the locking system can, in addition, be disabled in a positive or non-positive manner in locking direction by relieving and/or removing the loading device.

45. The transport system according to claim 42, wherein the locking system is also arranged to be disabled in a positive manner by relieving and/or removing the loading device by an elastic element.

46. The transport system according to claim 42, wherein the locking system is arranged to be disabled by relieving and/or removing the loading device by means of preloading force.

47. The transport system according to claim 34, wherein the locking system is arranged to be manually actuated both for locking and unlocking the loading floor.

48. The transport system according to claim 34, wherein at each of its corners which are each interacting with a floor support, the loading floor comprises a securing arm for securing the loading floor in the loading frame, wherein said securing arm can be swiveled in and out or pushed in and out and can be brought into and out of engagement with an opening in the associated floor support or post.

49. The transport system according to claim 34, wherein the loading floor comprises at least one receptacle for the fork of a forklift truck and/or fastening lifting accessories of a lifting appliance or crane.

50. The transport system according to claim 34, wherein the loading floor is comprises a frame.

51. The transport system according to claim 34, wherein the loading floor is equipped with at least one ball or roller track.

52. The transport system according to claim 34, wherein the cargo securing device comprises at least one of walls and a roof or cover on the loading floor.

53. The transport system according to claim 34, wherein the loading frame is mounted in the cargo area of the transport vehicle in a detachable and removable manner.

54. The transport system according to claim 53, wherein the loading frame is formed by a plurality of partial loading frames that are arranged to be individually detached and removed.

55. The transport system according to claim 54, wherein the loading frame or the partial loading frames thereof are arranged to be folded up and/or taken apart in their empty state.

56. The transport system according to claim 34, wherein the loading frame is arranged to be folded up and/or taken apart in its empty state.

57. The transport system according to claim 34, wherein the cargo area is designed with a securely mounted loading frame or as a loading frame.

58. The transport system according to claim 34, wherein at least a part of the posts of the loading frame is formed by stakes or walls or wall reinforcements of the cargo area body of the transport vehicle.

59. The transport system according to claim 34, wherein a floor of the cargo area itself is, at least in some of its regions, formed by one or a plurality of removable loading floors.

60. The transport system according to claim 34, wherein the posts of the loading frame comprise elements arranged to connect the posts to each other and/or to a cargo area body and/or to a vehicle frame.

61. The transport system according to claim 34, wherein intermediate or filler pieces are arranged to be mounted between loading floors that are neighboring each other.

62. The transport system according to claim 34, wherein the fastening elements of the loading floor which are intended for fastening the securing means are formed by floor regions that are reinforced in their material and/or shape and/or by fastening elements that are integrated in the loading floor.

63. The transport system according to claim 34, wherein the loading floor is provided with a stepped edge or a chamfered edge for the purpose of stacking a plurality of unloaded loading floors into each other.

64. The transport system according to claim 34, wherein the dimensions of the loading floor are arranged to be changed in at least one horizontal extension direction.

65. The transport system according to claim 34, wherein the floor supports and/or the loading floor comprise sliding elements at their contact surfaces.

66. The transport system according to claim 34, wherein the loading floor is provided with slide bars made of plastic at its lateral edges.

67. The transport system according to claim 34, wherein the cargo securing device comprises at least two tensile tractive means, the particular associated tensioning devices and connecting means for connecting the tractive means to the fastening elements of the loading floor, and that each tractive means can be tensioned separately via the associated tensioning device.
